(19) United States
(12) Patent Application Publication
(10) Pub. No.: US 2020/0388906 A1
(43) Pub. Date: Dec. 10, 2020

(54) ANTENNA MODULE AND ANTENNA APPARATUS

(71) Applicant: SAMSUNG ELECTRO-MECHANICS CO., LTD., Suwon-si (KR)

(72) Inventors: Nam Ki KIM, Suwon-si (KR); Jeong Ki RYOO, Suwon-si (KR); Seung Goo JANG, Suwon-si (KR); Sang Hyun KIM, Suwon-si (KR)

(73) Assignee: SAMSUNG ELECTRO-MECHANICS CO., LTD., Suwon-si (KR)

(21) Appl. No.: 17/000,679

(22) Filed: Aug. 24, 2020

Related U.S. Application Data
(63) Continuation of application No. 15/994,350, filed on May 31, 2018, now Pat. No. 10,790,573.

(30) Foreign Application Priority Data
Dec. 26, 2017 (KR) 10-2017-0179223

(51) Int. Cl. H01Q 1/24; H01Q 21/06; H01Q 9/06; H01Q 1/38; H01Q 1/22

(52) U.S. Cl. CPC H01Q 1/243; H01Q 21/062; H01Q 9/065; H01Q 5/48; H01Q 21/065; H01Q 1/2283; H01Q 1/38

(57) ABSTRACT

An antenna module includes a connection member, an integrated circuit (IC) on a first surface thereof, and an antenna package on a second surface thereof. The connection member includes a wiring layer and an insulating layer. The IC is electrically connected to the wiring layer. The antenna package includes first antenna members and feed vias each electrically connected to a corresponding one of the first antenna members and a corresponding wire of the wiring layer. A feed line is electrically connected to a wire of the wiring layer and extends in a side direction of the second surface, a second antenna member is electrically connected to the feed line and is configured to transmit and/or receive an RF signal in the side direction, and a director member is spaced apart from the second antenna member in the side direction and has an inside boundary oblique to the second antenna member.

### CROSS-REFERENCE TO RELATED APPLICATIONS

This application is a continuation of U.S. patent application Ser. No. 15/994,350 filed on May 31, 2018, which claims the benefit under 35 USC 119(a) of Korean Patent Application No. 10-2017-0179223 filed on Dec. 26, 2017, in the Korean Intellectual Property Office, the entire disclosures of which are incorporated herein by reference for all purposes.

### BACKGROUND

### 1. Field

This application relates to an antenna module and an antenna apparatus.

### 2. Description of the Background

Recently, millimeter wave (mmWave) communications including 5th generation (5G) communications have been actively researched, and research into the commercialization of an antenna module able to cohesively implement millimeter wave communications is being actively undertaken.

Conventionally, an antenna module providing a millimeter wave communications environment includes a structure in which an integrated circuit (IC) and an antenna are disposed on a board and are connected to each other by a coaxial cable in order to satisfy a high level of antennal performance (e.g., a transmission and reception rate, gain, directivity, and the like) according to a high frequency.

However, such a structure may cause a reduction of antenna layout space, a restriction of the degree of freedom of an antenna shape, an increase in interference between the antenna and the IC, and an increase in the size and cost of the antenna module.

The above information is presented as background information only to assist with an understanding of the present disclosure. No determination has been made, and no assertion is made, as to whether any of the above might be applicable as prior art with regard to the disclosure.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna module includes a connection member, an integrated circuit (IC) on a first surface thereof, and an antenna package on a second surface thereof. The connection member includes one or more wiring layer and one or more insulating layer. The IC is electrically connected to the one or more wiring layer. The antenna package includes first antenna members configured to transmit and/or receive a radio frequency (RF) signal in a first direction, and first feed vias each electrically connected to a corresponding one of the first antenna members and to a corresponding wire of the one or more wiring layer. A feed line is electrically connected to a wire of the one or more wiring layer and extending in a side direction of the second surface. A second antenna member is electrically connected to the feed line and configured to transmit and/or receive a RF signal in a second direction different than the first direction; and a director member spaced apart from the second antenna member in the second direction away from the center of the connection member and having an inside boundary disposed oblique to the second antenna member.

At the inside boundary, ends of the director member may be spaced a greater distance from the second antenna member than a center of the director member.

The second antenna member may include a dipole form or a folded dipole form including a first pole and a second pole. The director member may include a first portion parallel to the first pole and the second pole, a second portion oblique to the first pole and the second pole, a third portion parallel to the first pole and the second pole, a fourth portion oblique to the first pole and the second pole, and a fifth portion parallel to the first pole and the second pole connected to each other in order from the first portion to the fifth portion.

An angle of inclination of the second portion and an angle of inclination of the fourth portion in the director member may be greater than or equal to 5° and less than or equal to 14°.

The director member may be disposed to overlap between the first pole and the second pole when viewing the second antenna member in the second direction.

The director member may be longer than a length of the first pole, longer than a length of the second pole, and shorter than a unified length of the first pole and the second pole.

The director member may include a first portion protruding toward the first pole and a second portion protruding toward the second pole.

The director member may include a center portion protruding toward the second antenna member.

A thickness of the director member at an oblique portion of the inside boundary may be less than that of the director member at a portion of the inside boundary parallel to the second antenna member.

The connection member may further include one or more director via connected to the director member to dispose the inside boundary of the director member oblique.

The connection member may further include a second feed via electrically connected between the feed line and the second antenna member.

The connection member may further include a ground layer disposed on a same level as the feed line in the connection member and spaced apart from the feed line and shielding vias disposed extending parallel to each other along a boundary of the ground layer.

The antenna package may further include a dielectric layer disposed to surround a side surface of each of the first feed vias and having a height greater than that of the one or more insulating layer, and a plating member disposed in the dielectric layer to surround the side surface of each of the first feed vias.

In another general aspect, an antenna apparatus includes first and second feed lines each electrically connected to an integrated circuit (IC), first and second poles electrically connected to the first and second feed lines, respectively, and configured to transmit and/or receive a radio frequency (RF) signal in a predetermined direction, and a director member spaced apart from the first and second poles, disposed to overlap between the first and second poles when viewing the first and second poles in the predetermined direction, and having an oblique inside boundary facing the first and second poles, wherein distances between ends of the director member and the first and second poles are greater than distances between a center thereof and the first and second poles.

The antenna apparatus may further include a ground layer spaced apart from the first and second poles in a direction opposite to the director member and disposed to surround at least portions of the first and second feed lines. A length of a boundary toward the first and second poles in the ground layer may be longer than a unified length of the first pole and the second pole. The director member may be shorter than the unified length of the first and second poles.

Other features and aspects will be apparent from the following detailed description, the drawings, and the claims.

### BRIEF DESCRIPTION OF DRAWINGS

FIG. 1 is a view illustrating an example of an antenna module and an antenna apparatus according to a first embodiment of the present disclosure.

FIG. 2 is a view illustrating an example of an antenna module, an antenna apparatus, and a ground layer according to a second embodiment.

FIG. 3 is a view illustrating an example of an antenna module and an antenna apparatus according to a third embodiment.

FIG. 4A is a view illustrating an example of spaced distances, lengths, and angles of the antenna module and the antenna apparatus of the first embodiment.

FIG. 4B is a view illustrating example side surfaces of the antenna module and the antenna apparatus illustrated in FIG. 4A.

FIG. 5A is a view illustrating an example of an antenna module, an antenna apparatus, and a director via according to a fourth embodiment.

FIG. 5B is a view illustrating side surfaces of the antenna module and the antenna apparatus illustrated in FIG. 5A.

FIGS. 6A through 6F are views illustrating examples of various forms of directors of an antenna module and an antenna apparatus according to fifth through tenth embodiments.

FIG. 7 is a view illustrating examples of S-parameters of the antenna module and the antenna apparatus according to the eleventh through fourteenth embodiments of the present disclosure.

FIG. 8 is a view illustrating an example of an antenna module, an integrated circuit (IC), and an antenna package according to a fifteenth embodiment.

FIG. 9 is a view illustrating an example of an antenna module and an IC package according to a sixteenth embodiment.

FIG. 10 is a view illustrating an example of layout positions of an antenna module and an antenna apparatus according to a seventeenth embodiment.

FIGS. 11A and 11B are views illustrating example layouts of an antenna module in an electronic device according to eighteenth and nineteenth embodiments.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

An aspect of the present disclosure provides an antenna module and an antenna apparatus.

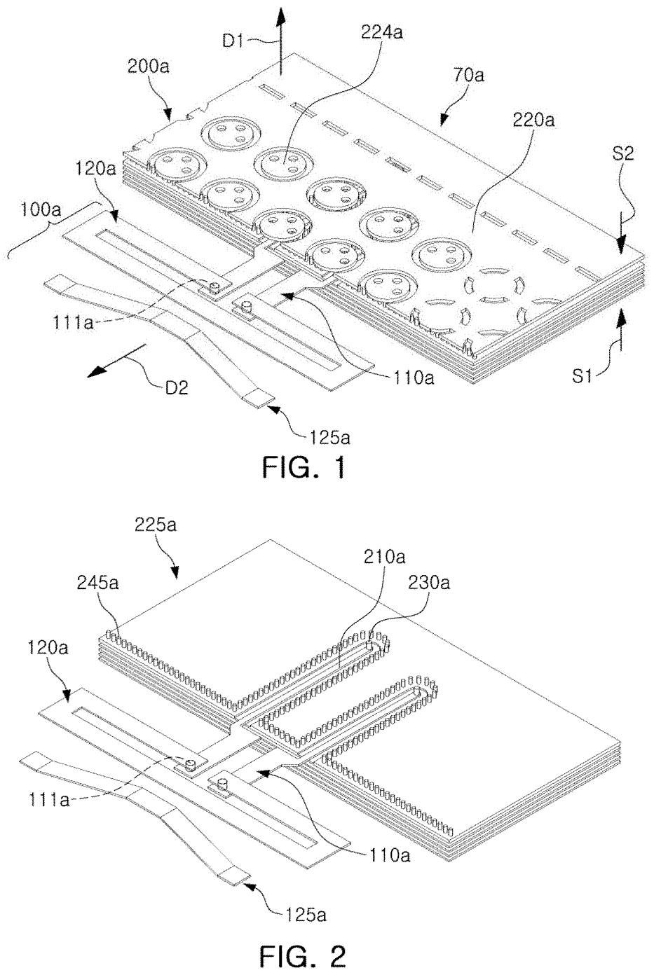

FIG. 1 is a view illustrating an example antenna module and an antenna apparatus according to a first embodiment of the present disclosure.

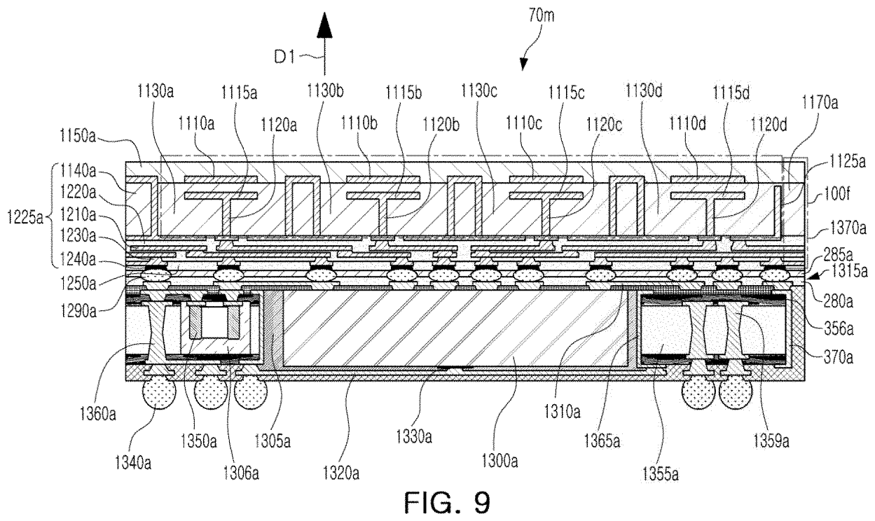

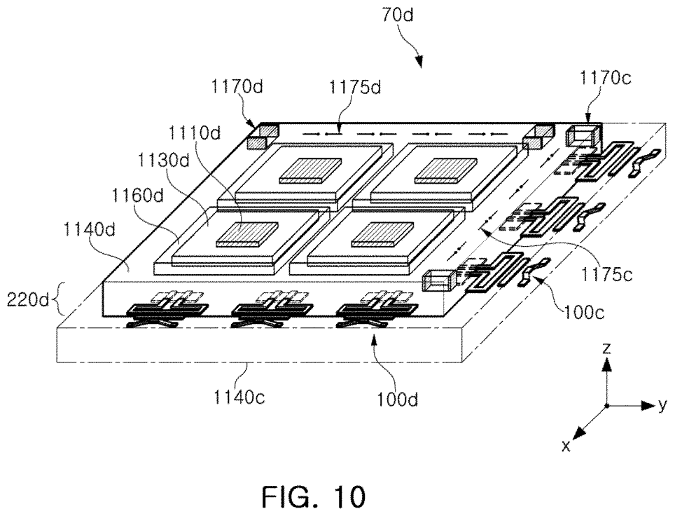

Referring to FIG. 1, an antenna module 70a includes a connection member 200a, an integrated circuit (IC) (1301b, 1300a described later with reference to FIGS. 8 and 9), and an antenna apparatus 100a. The connection member 200a includes one or more wiring layer and one or more insulating layer, and provides a first surface S1 (e.g., a lower surface) on which an integrated circuit (IC) is disposed and a second surface S2 (e.g., an upper surface) on which an antenna package 220a is disposed.

The antenna package 220a may be implemented to be homogeneous or heterogeneous with respect to the connection member 200a, and to transmit and/or receive (hereinafter transmit/receive) a radio frequency (RF) signal in a first direction D1 in which the second surface S2 of the connection member 200a is directed, that is, in a direction having a component generally perpendicular to the second surface S2. Therefore, the antenna module according to the first embodiment may form a radiation pattern in the first direction D1 so that the RF signal is transmitted and/or received (hereinafter transmitted/received) in the first direction D1.

The antenna package 220a includes first director members 224a disposed above corresponding first antenna members 1115b, first feed vias 1120b, a dielectric layer 1140b, an encapsulation member 1150b, and a plating member 1160b, described later with reference to FIGS. 8-10.

Referring to FIG. 1, the antenna apparatus 100a includes a feed line 110a, a second antenna member 120a, and a second director member 125a. Accordingly, the antenna module 70a and the antenna apparatus 100a may form a radiation pattern in a second direction D2 (e.g., a side surface) so that the RF signal is transmitted/received in the second direction D2, and may omni-directionally expand the transmission and/or reception (hereinafter transmission/reception) direction of the RF signal.

The feed line 110a is electrically connected to a wire of the one or more wiring layer. That is, the feed line 110a transmits the RF signal to the IC through the one or more wiring layer, and/or receives the RF signal from the IC through the one or more wiring layer.

The second antenna member 120a is electrically connected to the feed line 110a and configured to transmit/receive the RF signal. For example, the second antenna member 120a is disposed adjacent to side surfaces of the antenna module 70a, and has a folded dipole form. Here, a first end and a second end of the second antenna member 120a are electrically connected to first and second feed lines of the feed line 110a, respectively, and transmit/receive the RF signal in a differential feeding method.

The second antenna member 120a has a frequency band (e.g., 28 GHz) according to one or more of a pole length, a pole thickness, an interval between poles, an interval between a pole and a side surface of the connection member, and dielectric permittivity of the one or more insulating layer.

The second director member 125a is disposed spaced apart from the second antenna member 120a in a direction (the second direction D2) away from the center of the connection member 200a. The second director member 125a electromagnetically couples to the second antenna member 120a to improve a gain or a bandwidth of the second antenna member 120a. The second director member 125a has a length (e.g., 0.8 times of a dipole total length) shorter than a dipole total length of the second antenna member 120a and the second antenna member 120a increases the concentration of the electromagnetic coupling as the length of the second director member 125a decreases. Accordingly, directivity of the second antenna member 120a is further improved.

The second director member 125a has a structure in which an inside boundary 123a thereof toward the second antenna member 120a is oblique with respect to the second antenna member 120a. Accordingly, since a surface current flowing in the second antenna member 120a includes a component in a direction corresponding to the inside boundary, a bandwidth of the second antenna member 120a is increased and the radiation pattern formed by the second antenna member 120a has a wider distribution.

In addition, the bandwidth and the radiation pattern distribution of the second antenna member 120a can be varied depending on an angle of inclination of the inside boundary. The second director member 125a improves a degree of freedom of a design of the bandwidth and the radiation pattern distribution of the second antenna member 120a, and the second antenna member 120a has a more precisely adjusted antenna performance.

In addition, the second director member 125a is disposed to overlap the second antenna member 120a between a first pole and a second pole of the dipole when viewing the second antenna member 120a from the second direction D2. Accordingly, the second antenna member 120a further concentrates the electromagnetic coupling to the second director member 125a.

The antenna apparatus 100a according to the first embodiment further includes a second feed via 111a electrically connected between the feed line 110a and the second antenna member 120a. Due to the second feed via 111a, the second antenna member 120a may be disposed at a position higher or lower than the feed line 110a. Since a detailed position of the second antenna member 120a may be varied depending on a length of the second feed via 111a, a direction of the radiation pattern of the second antenna member 120a may be appropriately adjusted according to a predetermined length of the second feed via 111a.

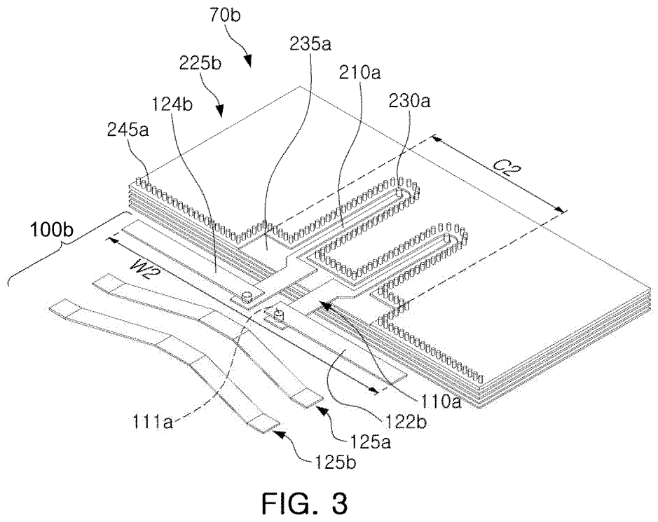

FIG. 2 is a view illustrating an example of an antenna module, an antenna apparatus, and a ground layer according to a second embodiment of the present disclosure.

Referring to FIG. 2, the connection member of the antenna module includes a ground layer 225a disposed on the same level as the feed line 110a and disposed to be spaced apart from the feed line 110a.

The ground layer 225a acts as a reflector with respect to the second antenna member 120a. That is, the ground layer 225a assists antenna performance (e.g., a transmission/reception rate, a gain, a bandwidth, directivity, and the like) of the second antenna member 120a.

Referring to FIG. 2, the connection member of the antenna module further includes shielding vias 245a disposed in parallel adjacent to a boundary of the ground layer 225a.

The shielding vias 245a reduce transmission loss of the RF signal of a wiring layer 210a of the one or more wiring layer of the connection member, act as reflectors with respect to the second antenna member 120a, and improve isolation of the second antenna member 120a relative to the wiring layer 210a.

The wiring layer 210a is electrically connected to a wiring via 230a to be thereby electrically connected to the IC. The wiring layer 210a is integrated into the feed line 110a. Here, the ground layer 225a is disposed to surround at least a portion of the feed line 110a.

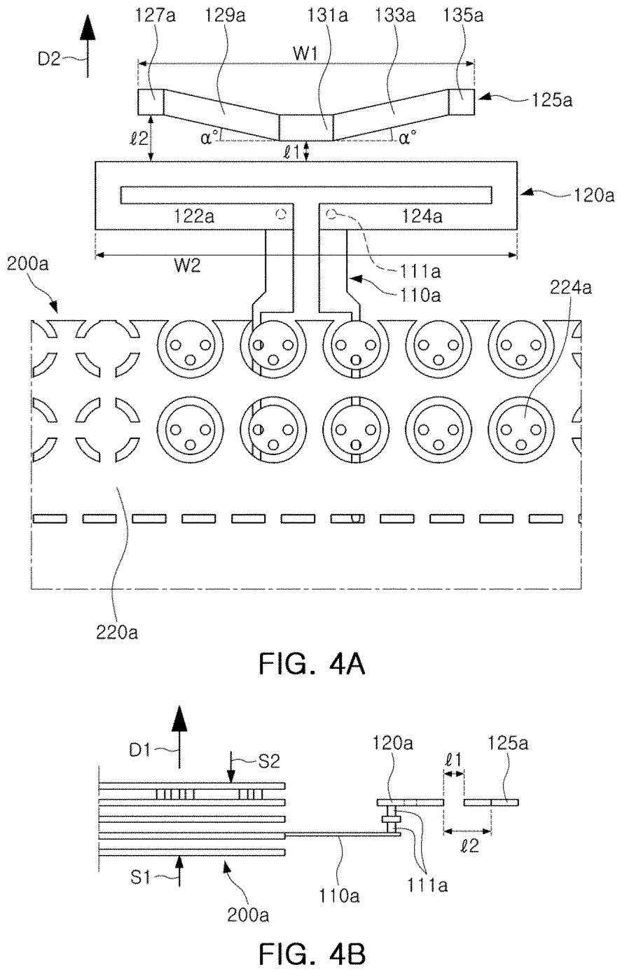

FIG. 3 is a view illustrating an example of an antenna module 70b and an antenna apparatus 100b according to a third embodiment of the present disclosure.

A distance from a boundary of a ground layer 225b to a second antenna member 120b influences antenna performance of the second antenna member 120b. In order to satisfy antenna performance required for a predetermined design, the second antenna member 120b is spaced apart from the ground layer 225b by a distance greater than a predetermined length.

Referring to FIG. 3, the boundary of the ground layer 225b on a side facing the second antenna member 120b is closer to the center of the connection member. For example, a partial region 235a of the ground layer 225b is disposed so that the boundary of the ground layer 225b has a concave shape.

Accordingly, a range of the distance from the boundary of the ground layer 225b to the second antenna member 120b is increased, and the second antenna member 120b is disposed closer to the center of the connection member without substantially sacrificing antenna performance.

A width C2 of the partial region 235a may be greater than the dipole total length W2 of the second antenna member 120b. For example, the partial region 235a width C2 is 1.7 times the dipole total length W2. Accordingly, the second antenna member 120b further concentrates the electromagnetic coupling to the second director member 125a, 125b.

In addition, the antenna apparatus 100b according to the third embodiment of the present disclosure further includes an additional second director member 125b spaced apart from the second director member 125a so as to correspond to the second director member 125a. In such a case in which the number of second director members is increased, the second antenna performance such as the bandwidth of the second antenna member 120b may be improved.

Referring to FIG. 3, the second antenna member 120b has a dipole form including two poles 122b, 124b. A detailed form of the second antenna member 120b may be varied depending on predetermined design factors including, for example, a detailed wiring layout of the connection member, whether an IC package is applied, characteristics of the second antenna member, frequency characteristics of the RF signal, a process of manufacturing an antenna module, an entire size of the antenna module, a manufacturing cost of the antenna module, and the like.

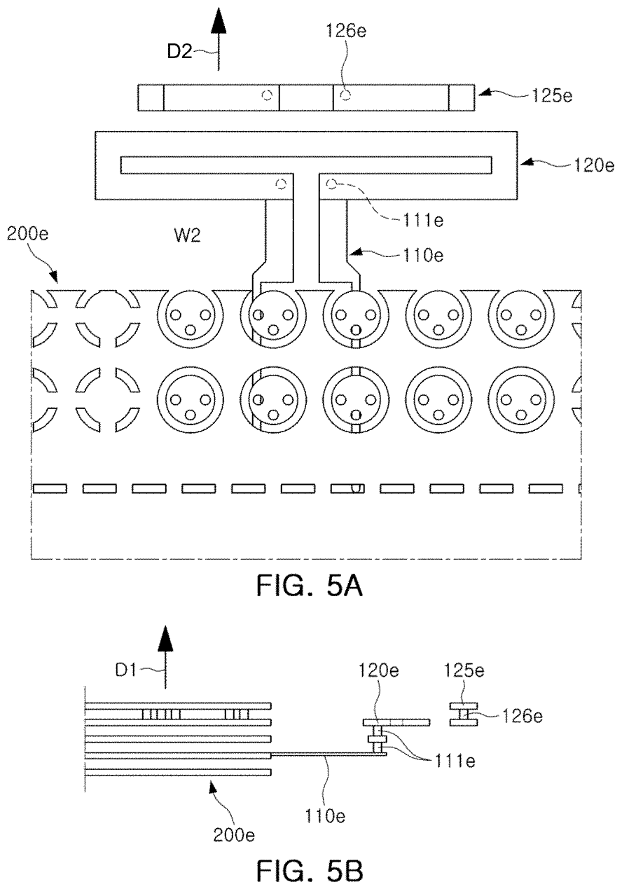

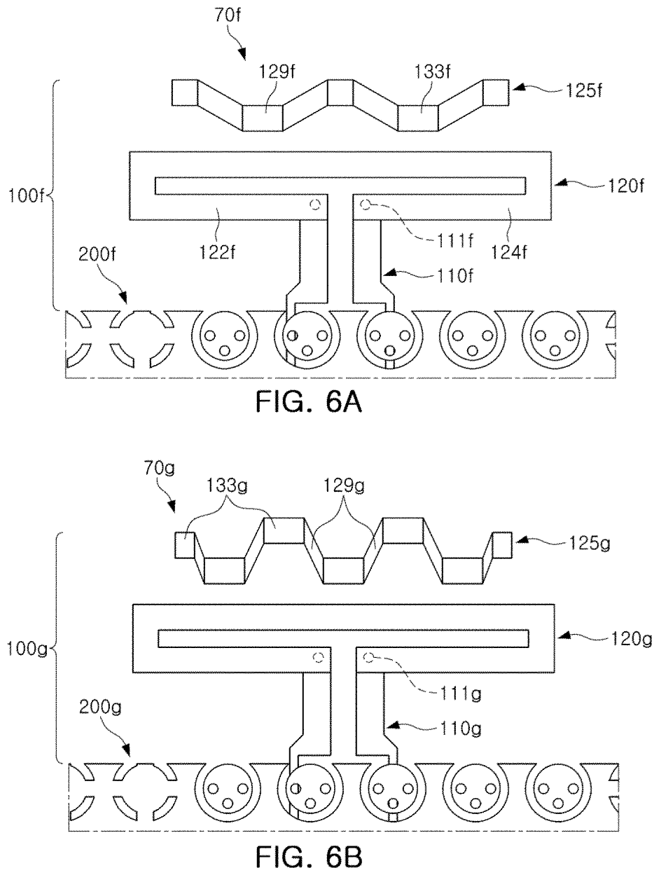

FIG. 4A is a view illustrating an example of spaced distances, lengths, and angles of the antenna module 70a and the antenna apparatus 100a according to the first embodiment.

Referring to FIG. 4A, the second director member 125a has a structure in which an inside boundary thereof is oblique so that a spaced distance 12 between ends of the second director member 125a and the second antenna member 120a is greater than a spaced distance 11 between the center of the second director member 125a and the second antenna member 120a. Accordingly, the bandwidth of the second antenna member 120a is increased, and the radiation pattern formed by the second antenna member 120a has a wider distribution.

Referring to FIG. 4A, the second director member 125a has a length W1 which is longer than a length (a half of W2) of the first pole 122a, is longer than a length (a half of W2) of the second pole 124a, and is shorter than a unified length W2 of the first pole 122a and the second pole 124a when viewing the second antenna member 120a from the first direction D1 (FIG. 4A plan view). Accordingly, the second antenna member 120a concentrates the electromagnetic coupling to the second director member 125a and effectively receives an influence due to the oblique boundary of the second director member 125a.

Referring to FIG. 4A, the second director member 125a has a structure in which a first portion 127a is parallel to the first pole 122a and the second pole 124a of the second antenna member 120a, a second portion 129a oblique to the first pole 122a and the second pole 124a, a third portion 131a parallel to the first pole 122a and the second pole 124a, a fourth portion 133a oblique to the first pole 122a and the second pole 124a, and a fifth portion 135a parallel to the first pole 122a and the second pole 124a, where the first portion 127a through the fifth portion 135a are sequentially connected to each other. Accordingly, the second antenna member 120a concentrates the electromagnetic coupling to the second director member 125a and effectively receives an influence due to the oblique boundary of the second director member 125a.

Referring to FIG. 4A, an angle of the oblique boundary a in the second director member 125a is in a range of 5° or more to 14° or less, but is not limited thereto.

FIG. 4B is a view illustrating example side surfaces of the antenna module and the antenna apparatus illustrated in FIG. 4A.

Referring to FIG. 4B, one end of the feed line 110a is connected to the connection member 200a, and the other end of the feed line 110d is connected to the second feed via 111a. Accordingly, the second antenna member 120a is disposed on a higher layer than the feed line 110a. In addition, the second director member 125a is disposed on the same level as the second antenna member 120a.

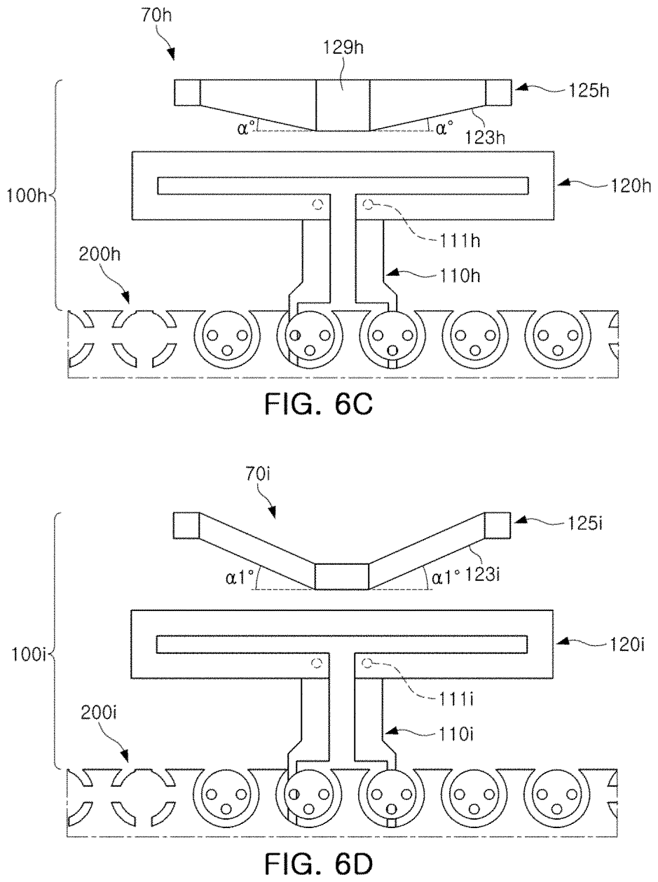

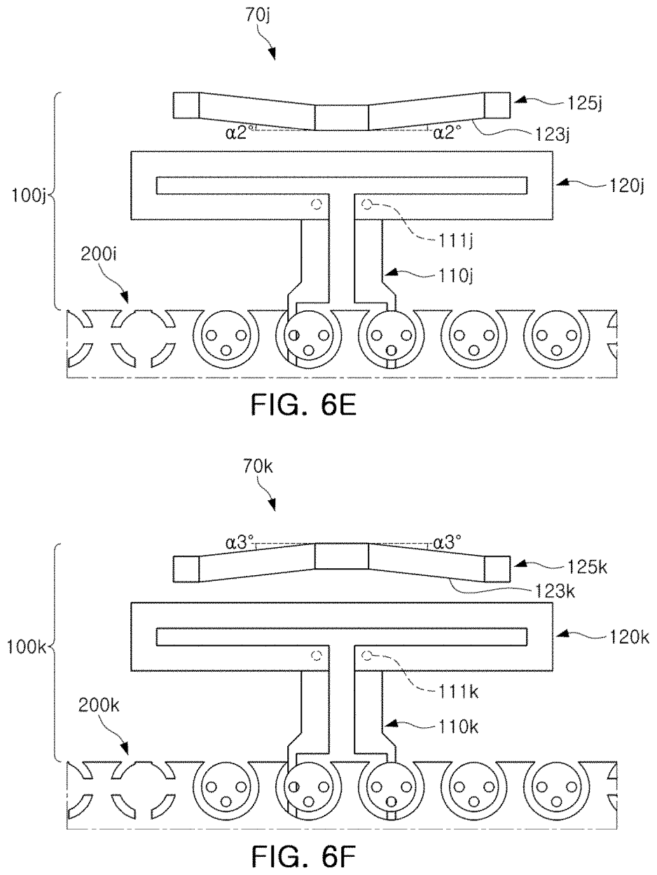

FIG. 5A is a view illustrating an example antenna module, an antenna apparatus, and a director via according to a fourth embodiment of the present disclosure.

Referring to FIG. 5A, the antenna apparatus further includes one or more director via 126e connected to a second director member 125e so that an inside boundary of the second director member 125e extends oblique in the first direction D1 relative to the second antenna member 120e. That is, the ends of the second director member 125e are disposed on a higher layer than the center of the second director member 125e. Accordingly, a bandwidth of the second antenna member 120e is increased, and a radiation pattern formed by the second antenna member 120e has a wider distribution.

FIG. 5B is a view illustrating example side surfaces of the antenna module and the antenna apparatus illustrated in FIG. 5A.

Referring to FIG. 5B, one end of a feed line 110e is connected to a connection member 200e, and the other end of the feed line 110e is connected to a second feed via 111e. Accordingly, the second antenna member 120e is disposed on a higher layer than the feed line 110e. In addition, the second director member 125e is disposed to extend from the same level as the second antenna member 120e to a higher layer than the second antenna member 120e through a director via 126e.

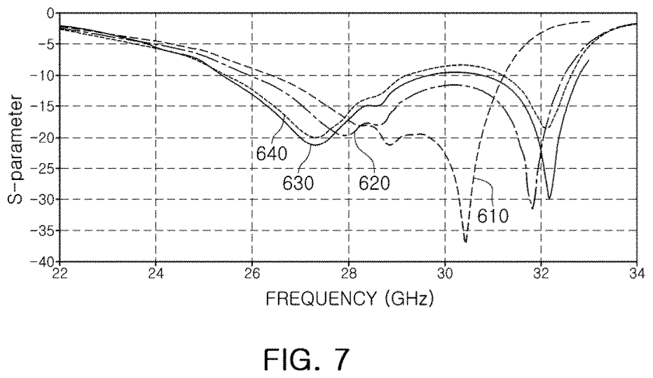

FIGS. 6A through 6F are views illustrating examples of various forms of second directors of an antenna module and an antenna apparatus according to fifth through tenth embodiments of the present disclosure.

Referring to FIG. 6A, an example of the antenna module 70f and the antenna apparatus 100f according to the fifth embodiment of the present disclosure includes at least portions of a feed line 110f, a second feed via 111f, a second antenna member 120f, a second director member 125f, and a connection member 200f. Here, the second director member 125f simultaneously has a first portion 129f protruding to a first pole 122f of the second antenna member 120f and a second portion 133f protruding to a second pole 124f of the second antenna member 120f. Accordingly, directivity of the second antenna member 120f is improved.

Referring to FIG. 6B, an example of the antenna module 70g and the antenna apparatus 100g according to the sixth embodiment of the present disclosure includes at least portions of a feed line 110g, a second feed via 111g, a second antenna member 120g, a second director member 125g, and a connection member 200g. Here, a thickness of a first portion 129g of the second director member 125g having an oblique inside boundary is less than a thickness of a second portion 133g of the second director member 125g having a parallel inside boundary. Accordingly, the second antenna member 120g effectively receives an influence due to the oblique boundary of the second director member 125g.

Referring to FIG. 6C, an example of the antenna module 70h and the antenna apparatus 100h according to the seventh embodiment of the present disclosure includes at least portions of a feed line 110h, a second feed via 111h, a second antenna member 120h, a second director member 125h, and a connection member 200h. Here, the second director member 125h has a structure in which the center 129h thereof protrudes to the second antenna member 120h. For example, the center 129h is wider than the ends of the second director member 125h. Accordingly, the second antenna member 120h effectively receives an influence due to the oblique boundary 123h of the second director member 125h.

Referring to FIG. 6D, an example of the antenna module 70i and the antenna apparatus 100i according to the eighth embodiment of the present disclosure includes at least portions of a feed line 110i, a second feed via 111i, a second antenna member 120i, a second director member 125i, and a connection member 200i. Here, an angle α1 of an oblique boundary 123i of the second director member 125i is greater than 14°.

Referring to FIG. 6E, an example of the antenna module 70j and the antenna apparatus 100j according to the ninth embodiment of the present disclosure includes at least portions of a feed line 110j, a second feed via 111j, a second antenna member 120j, a second director member 125j, and a connection member 200j. Here, an angle α2 of an oblique boundary 123j of the second director member 125j is less than 5°.

Referring to FIG. 6F, an example of the antenna module 70k and the antenna apparatus 100k according to the tenth embodiment of the present disclosure includes at least portions of a feed line 110k, a second feed via 111k, a second antenna member 120k, a second director member 125k, and a connection member 200k. Here, an angle α3 of an oblique boundary 123k in the second director member 125k is less than 0°.

A detailed form of the second director may be varied depending on predetermined design factors, including, for example, a detailed wiring layout of the connection member, whether an IC package is applied, characteristics of the second antenna member, frequency characteristics of the RF signal, a process of manufacturing an antenna module, an entire size of the antenna module, a manufacturing cost of the antenna module, and the like.

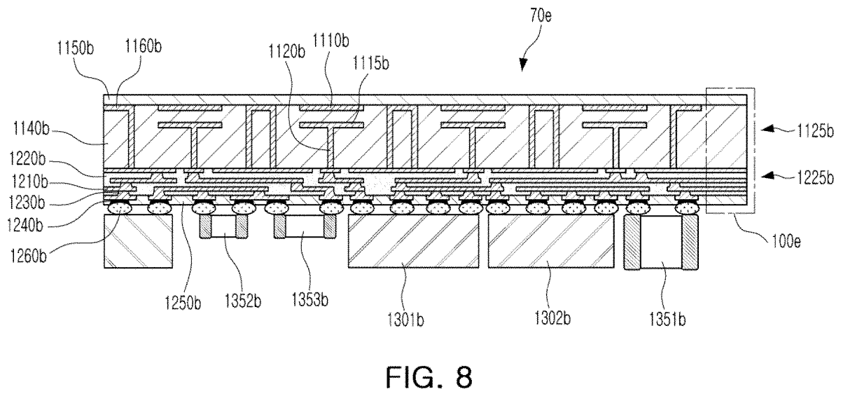

FIG. 7 is a view illustrating S-parameters of example antenna module and antenna apparatus according to eleventh through fourteenth embodiments of the present disclosure. The S-parameter represents a ratio of energy reflected to a first port to energy incident from the first port.

Referring to FIG. 7, a bandwidth of an S-parameter 610 of a first case in which an angle of an oblique boundary in the second director member is 0° in the eleventh embodiment is narrower than a bandwidth of an S-parameter 620 of a second case in which the angle of the oblique boundary in the second director member is 5° in the twelfth embodiment, a bandwidth of an S-parameter 630 of a third case in which the angle of the oblique boundary in the second director member is 14° in the thirteenth embodiment, and a bandwidth of an S-parameter 640 of a fourth case in which the angle of the oblique boundary in the second director member is 24° in the fourteenth embodiment. That is, the example antenna module and antenna apparatus according to the twelfth through fourteenth embodiments of the present disclosure increase the bandwidth compared to the eleventh embodiment. However, even the example antenna module and antenna apparatus according to the eleventh embodiment of the present disclosure increases the bandwidth.

Referring to FIG. 7, a value (about −31 dB) at about 32 GHz of the S-parameter 620 of the second case and a value (about −30 dB) at about 32 GHz of the S-parameter 630 of the third case may be greatly lower than a value (about −18 dB) at about 32 GHz of the S-parameter 640 of the fourth case. That is, in a case in which the angle of the oblique boundary in the director member included in the antenna module and the antenna apparatus is set to greater than or equal to 5° and less than or equal to 14°, the antenna module and the antenna apparatus exhibited additional antenna performance. However, since the additional antenna performance may not be required in all embodiments, for example, depending on a predetermined design factor, the angle is not intended to be limited thereto.

FIG. 8 is a view illustrating an example of an antenna module, an integrated circuit (IC), and an antenna package according to a fifteenth embodiment of the present disclosure.

Referring to FIG. 8, an example of an antenna module 70e according to the fifteenth embodiment of the present disclosure has a heterogeneous structure in which an antenna package 1125b and a connection member 1225b are coupled to each other. That is, the antenna module 70e may be miniaturized while improving antenna performance, including, for example, a transmission/reception rate, a gain, directivity, and the like, by utilizing both characteristics that facilitate improvement in the antenna performance of the antenna package 1125b and characteristics that facilitate disposal of a circuit pattern and/or an integrated circuit (IC) on or in the connection member 1225b.

The connection member 1225b includes one or more wiring layer 1210b and one or more insulating layer 1220b. The connection member 1225b includes a wiring via 1230b connected to one or more wiring layer 1210b and a connection pad 1240b connected to the wiring via 1230b, and may have a structure similar to a copper redistribution layer (RDL). A passivation layer 1250b is disposed on lower surface of the connection member 1225b exposing the connection pad 1240b. The antenna package 1125b is disposed on an upper surface of the connection member 1225b.

The antenna package includes at least portions of first director members 1110b, first antenna members 1115b, first feed vias 1120b, a dielectric layer 1140b, an encapsulation member 1150b, and a plating member 1160b.

The first director members 1110b are disposed adjacent to one surface (an upper surface of FIG. 8) of the antenna module 1125b, and transmit/receive an RF signal generated by an IC 1301b together with the first antenna members 1115b disposed at a lower end of respective first director members 1110b.

Depending on a predetermined design, the first director members 1110b may be omitted, or one or more additional first director member may be further disposed on respective first director members 1110b.

The first antenna members 1115b can be electromagnetically coupled to respective first director members 1110b disposed at an upper end thereof, and can receive the RF signal and/or transmit the RF signal generated by the IC 1301b together with a corresponding first director member 1110b. For example, the first antenna members 1115b have a shape (e.g., a patch antenna, or the like) similar to that of the corresponding first director member 1110b.

The first feed vias 1120b are electrically connected to respective first antenna members 1115b to provide a path of the RF signal. The first feed vias 1120b extend up to a length longer than a thickness of one or more insulating layer 1220b of the connection member 1225b. Accordingly, transmission efficiency of the RF signal is improved.

The dielectric layer 1140b is disposed to surround a side surface of each of the first feed vias 1120b. The dielectric layer 1140b has a height greater than that of the one or more insulating layer 1220b of the connection member 1225b. The antenna package 1125b provides improved antenna performance as a height and/or width of the dielectric layer 1140b is increased, and provides boundary conditions (e.g., a small manufacturing tolerance, a short electrical length, a smooth surface, a large size of the dielectric layer, an adjustment of a dielectric constant, structurally securing the antenna package 1125b elements, and the like), and greater transmission/reception operation of RF signal of the first antenna members 1115b.

For example, the dielectric layer 1140b and at least one of the one or more insulating layer 1220b may be formed of a thermosetting resin such as an epoxy resin, a thermoplastic resin such as a polyimide resin, a resin in which the thermosetting resin or the thermoplastic resin is impregnated together with an inorganic filler in a core material such as a glass fiber (or a glass cloth or a glass fabric), for example, prepreg, Ajinomoto Build up Film (ABF) (AJINOMOTO FINE-TECHNO CO., INC.), FR-4, Bismaleimide Triazine (BT), a photo imagable dielectric (PID) resin, generic copper clad laminate (CCL), a glass based material, a ceramic based material, or a combination thereof.

The dielectric layer 1140b has a dielectric constant greater than a dielectric constant Dk of the one or more insulating layer 1220b. For example, the dielectric layer 1140b may be formed of glass, ceramic, or silicon having a large dielectric constant (e.g., 5 or more), and the one or more insulating layer 1220b may be formed of copper clad laminate (CCL) or prepreg having a relatively lower dielectric constant.

The encapsulation member 1150b is disposed on the dielectric layer 1140b, and improves durability against impact or oxidation of the first antenna members 1115b and the first director members 1110b. For example, the encapsulation member 1150b may be formed of a photo imageable encapsulant (PIE), Ajinomoto build-up film (ABF) (AJINOMOTO FINE-TECHNO CO., INC.), epoxy molding compound (EMC), and the like, or combinations thereof, but is not limited thereto.

The plating member 1160b is disposed in the dielectric layer 1140b to surround each of a side surface of each of the first feed vias 1120b. That is, the plating member 1160b forms cavities corresponding to each of the first antenna members 1115b to provide a boundary condition for transmission/reception of the RF signal of the corresponding first antenna member 1115b.

An IC 1301b, a PMIC 1302b, and passive components 1351b, 1352b, and 1353b are disposed on a lower surface of the connection member 1225b. The IC 1301b, a PMIC 1302b, and passive components 1351b, 1352b, and 1353b may be coupled to the connection member 1225b through an electrical connection structure 1260b and the passivation layer 1250b or the electrical connection structure 1260b and the passivation layer 1250b may be omitted depending on a predetermined design.

The IC 1301b generates an RF signal transmitted to the first antennal members 1115b and/or receives an RF signal from the first antenna members 1115b.

The PMIC 1302b generates power and transmits the generated power to the IC 1301b through at least one wire of the one or more wiring layer 1210b of the connection member 1225b.

The passive components 1351b, 1352b, and 1353b provide impedance to the IC 1301b and/or the PMIC 1302b. For example, the passive components 1351b, 1352b, and 1353b include at least a portion of a capacitor (e.g., a multilayer ceramic capacitor (MLCC)), an inductor, or a chip resistor.

The connection member 1225b includes the antenna apparatus 100e described above, for example, in the first through fourteenth embodiments with reference to FIGS. 1 through 7.

Meanwhile, depending on a predetermined design, the antenna package 1125b may be implemented to be homogeneous with the connection member 1225b. For example, the antenna package 1125b includes of the first antenna members 1115b each implemented through a ground pattern, and first feed vias 1120b implemented to each have a structure in which the first feed vias 1120b are connected to each other. Whether the antenna package 1125b is homogeneous/heterogeneous with the connection member 1225b is determined by the characteristics of the dielectric layer 1140b.

FIG. 9 is a view illustrating an example of an antenna module and an IC package according to a sixteenth embodiment of the present disclosure.

Referring to FIG. 9, an IC package includes an IC 1300a, an encapsulant 1305a encapsulating at least a portion of the IC 1300a, a core member 1355a disposed so that a first side surface thereof faces the IC 1300a, and a first connection member 1315a including one or more first wiring layer 1310a and one or more first insulating layer 280a electrically connected to the IC 1300a and the core member 1355a, and coupled to a second connection member 1225a or an antenna package 1125a.

The second connection member 1225a includes one or more second wiring layer 1210a, one or more second insulating layer 1220a, a wiring via 1230a, a connection pad 1240a, and a passivation layer 1250a. The antenna package 1125a includes first director members 1110a, 1110b, 1110c, and 1110d, first antenna members 1115a, 1115b, 1115c, and 1115d, first feed vias 1120a, 1120b, 1120c, and 1120d, cavities 1130a, 1130b, 1130c, and 1130d, a dielectric layer 1140a, an encapsulation member 1150a, and a plating member 1170a.

The IC package is coupled to the first connection member 1315a described above. A first RF signal generated from the IC 1300a included in the IC package can be transmitted to the antenna package 1125a through at least one wire of the one or more first wiring layer 1310a and can be transmitted in an upper surface direction (first direction D1) of the antenna module 70m, and a first RF signal received by the antenna package 70m can be transmitted to the IC 1300a through at least one wire of the one or more first wiring layer 1310a.

The IC package further includes connection pads 1330a disposed on an upper surface and/or a lower surface of the IC 1300a. The connection pad 1330a disposed on the upper surface of the IC 1300a is electrically connected to at least one wire of the one or more first wiring layer 1310a, and the connection pad 1330a disposed on the lower surface of the

IC 1300a is electrically connected to the core member 1355a or the core plating member 1365a through a lower end wiring layer 1320a. The core plating member 1365a provides a ground region to the IC 1300a.

The core member 1355a includes a core dielectric layer 356a in contact with the first connection member 1315a, core wiring layers 1359a disposed on an upper surface and/or a lower surface of the core dielectric layer 356a, and at least one core via 1360a penetrating through the core dielectric layer 356a, electrically connecting the core wiring layers 1359a, and electrically connected to the connection pads 1330a. One or more core via 1360a is electrically connected to an electrical connection structure 1340a such as a solder ball, a pin, and a land.

Accordingly, the core member 1355a receives a base signal or power from a lower surface thereof and transmits the base signal and/or power to the IC 1300a through the one or more first wiring layer 1310a of the first connection member 1315a.

The IC 1300a generates an RF signal of a millimeter wave (mmWave) band using the base signal and/or power. For example, the IC 1300a receives a base signal of a low frequency and performs a frequency conversion, amplification, a filtering phase control, and a power generation of the base signal, and may be formed of a compound semiconductor (e.g., GaAs) or a silicon semiconductor in consideration of high frequency characteristics.

The IC package further includes a passive component 1350a electrically connected to a corresponding wire of the one or more first wiring layer 1310a. The passive component 1350a is disposed in an accommodation space 1306a provided by the core member 1355a and provides impedance to the IC 1300a and/or one or more second directional antennal member 1370a. For example, the passive component 1350a includes at least a portion of a multilayer ceramic capacitor (MLCC), an inductor, or a chip resistor.

The IC package includes core plating members 1365a and 370a disposed on side surfaces of the core member 1355a. The core plating members 1365a and 370a can provide a ground region to the IC 1300a, radiate heat of the IC 1300a to the outside, and remove noise of the IC 1300a.

The IC package and the antenna package 1125a may be manufactured and coupled independently of each other or may be manufactured together depending on a predetermined design. That is, a separate coupling process between two or more packages may be omitted.

The IC package may be coupled to the second connection member 1225a through the electrical connection structure 1290a and the passivation layer 285a or the electrical connection structure 1290a and the passivation layer 285a may be omitted depending on a predetermined design.

The second connection member 1225a may include the antenna apparatus 100f described above, for example, in the first through fourteenth embodiments with reference to FIGS. 1 through 7. For example, the antenna apparatus 100f includes a feed line 110a, a second antenna member 120a, and a second director member 125a (FIG. 1).

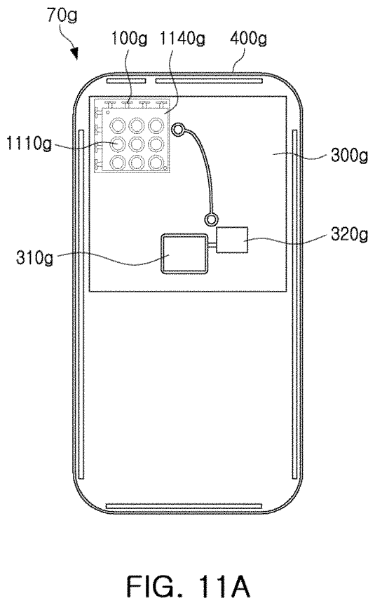

FIG. 10 is a view illustrating an example of layout positions of an antenna module and an antenna apparatus according to a seventeenth embodiment of the present disclosure.

Referring to FIG. 10, an antenna module 70d according to the seventeenth embodiment of the present disclosure includes one or more first director members 1110d, a cavity 1130d, a dielectric layer 1140d, a plating member 1160d, one or more first chip antennas 1170c and 1170d, and one or more first dipole antennas 1175c and 1175d.

The one or more first director members 1110d transmit/receive an RF signal in a z axis direction (first direction D1) together with a corresponding first antenna member. The number, layout, and shape of the one or more first director members 1110d and the first antenna members disposed at a lower end of each thereof are not particularly limited. For example, the shape of the one or more first director members 1110d may be a circular shape, and the number of the one or more first director members 1110d may be two or more.

The one or more chip antennas 1170c and 1170d are disposed to be adjacent to an edge of the antenna package and stood up in a z axis direction. One of the plurality of chip antennas 1170c and 1175d is configured to transmit/receive the RF signal in an x axis direction and the other thereof is configured to transmit/receive the RF signal in a y axis direction. Since the one or more chip antennas 1170c and 1170d are disposed in the antenna package 220d, the antenna module 70d significantly reduces a problem of a size increase due to an increase in the number of first chip antennas 1170c and 1170d.

The first dipole antennas 1175c and 1175d are disposed between the first dielectric layer 1140d and an encapsulation member to be adjacent to the edge of the antenna package. A first portion of the first dipole antennas 1175d is configured to transmit/receive a RF signal in the x axis direction and a second portion of the first dipole antennas 1175c is configured to transmit/receive a RF signal in the y axis direction. Depending on a predetermined design, one or more of the first dipole antennas 1175c and 1175d may be replaced with a respective monopole antenna.

In addition, the antenna module 70d includes one or more antenna apparatuses 100c and 100d described above, for example, in the first through fourteenth embodiments with reference to FIGS. 1 through 7. A first portion of the one or more antenna apparatuses 100d are configured to transmit/receive a RF signal in the x axis direction and a second portion of the one or more antenna apparatuses 100c are configured to transmit/receive a RF signal in the y axis direction.

In addition, the antenna apparatuses 100c and 100d are arranged to be parallel to a side direction of the antenna module and may be encapsulated by a second dielectric layer 1140c.

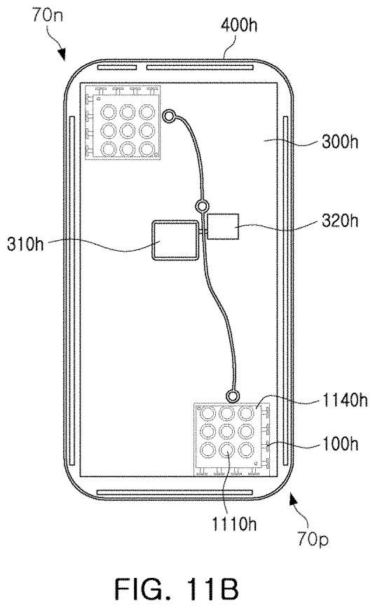

FIGS. 11A and 11B are views illustrating example layouts of an antenna module in an electronic device according to eighteenth and nineteenth embodiments of the present disclosure.

Referring to FIG. 11A, an antenna module 70g including an antenna apparatus 100g, a first director member 1110g, and a dielectric layer 1140g are disposed to be adjacent to a side boundary of an electronic device 400g on a substrate 300g of the electronic device 400g.

The electronic device 400g may be a smartphone, a personal digital assistant, a digital video camera, a digital still camera, a network system, a computer, a monitor, a tablet, a laptop, a netbook, a television, a video game, a smartwatch, an automotive component, or the like, but is not limited thereto.

A communications module 310g and a baseband circuit 320g are further disposed on the substrate 300g. The communications module 310g includes at least a portion of a memory chip such as a volatile memory (for example, a DRAM), a non-volatile memory (for example, a ROM), a flash memory, or the like; an application processor chip such as a central processor (for example, a CPU), a graphics processor (for example, a GPU), a digital signal processor, a cryptographic processor, a microprocessor, a microcontroller, or the like; and a logic chip such as an analog-digital converter, an application-specific IC (ASIC), or the like.

The baseband circuit 320g generates a base signal by performing analog-digital conversion, and amplification, filtering, and frequency conversion of an analog signal. The base signal input and output from the baseband circuit 320g is transmitted to the antenna module through a cable.

For example, the base signal is transmitted to the IC through the electrical connection structure, the core via, and the wiring layer illustrated in FIG. 9. For example, the IC converts the base signal into an RF signal of a millimeter wave (mmWave) band.

Referring to FIG. 11B, two or more antenna modules 70n, 70p each including an antenna apparatus 100h, a first director member 1110h, and a dielectric layer 1140h are disposed to be adjacent to a boundary of one side surface of an electronic device 400h and a boundary of the other side surface thereof, respectively, on a substrate 300h of the electronic device 400h. A communications module 310h and a baseband circuit 320h are further disposed on the substrate 300h.

The wiring layer, the feed line, the feed via, the antenna member, the ground layer, the shielding via, the director member, the director via, the feed via, the electrical connection structure, and the plating member disclosed herein may include a metal material (e.g., a conductive material such as copper (Cu), aluminum (Al), silver (Ag), tin (Sn), gold (Au), nickel (Ni), lead (Pb), titanium (Ti), an alloy thereof, or combinations thereof), and may be formed by a plating method such as chemical vapor deposition (CVD), physical vapor deposition (PVD), sputtering, subtractive, additive, semi-additive process (SAP), modified semi-additive process (MSAP), and the like, or combinations thereof, but is not limited thereto.

The RF signal disclosed herein may have a format according to wireless fidelity (Wi-Fi) (Institute of Electrical And Electronics Engineers (IEEE) 802.11 family, or the like), worldwide interoperability for microwave access (WiMAX) (IEEE 802.16 family, or the like), IEEE 802.20, long term evolution (LTE), evolution data only (Ev-DO), high speed packet access+ (HSPA+), high speed downlink packet access+ (HSDPA+), high speed uplink packet access+ (HSUPA+), enhanced data GSM environment (EDGE), global system for mobile communications (GSM), global positioning system (GPS), general packet radio service (GPRS), code division multiple access (CDMA), time division multiple access (TDMA), digital enhanced cordless telecommunications (DECT), Bluetooth, 3G, 4G, and 5G protocols, and any other wireless and wired protocols designated after the abovementioned protocols, but is not limited thereto.

As set forth above, according to the examples and embodiments of the present disclosure, the antenna module may omni-directionally expand the transmission and reception direction of the RF signal by forming the radiation patterns for transmission and reception of the RF signal in the first and second directions which are different from each other, and may improve the antenna performance (e.g., the transmission and reception rate, the gain, the bandwidth, directivity, and the like) in the second direction.

In addition, the example antenna modules according to the embodiments of the present disclosure may be easily miniaturized while improving the transmission and reception performance of the RF signal in the first and second directions.

The example antenna modules according to the embodiments of the present disclosure may have precisely adjusted antenna performance by improving a degree of freedom of a design of the director member.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna apparatus, comprising:
a feed line extended in a forward direction;
a dipole antenna member electrically connected to the feed line and having first and second poles; and
a director member disposed in front of the first and second poles,
wherein the director member is bent so that first and second end portions of the director member are more forwardly positioned than a center portion of the director member.

2. The antenna apparatus of claim 1, wherein the director member is longer than a length of the first pole, longer than a length of the second pole, and shorter than a unified length of the first pole and the second pole.

3. The antenna apparatus of claim 2, wherein the director member comprises a first bent portion connected between the first end portion and the center portion, and a second bent portion connected between the second end portion and the center portion, and
wherein an angle of inclination of the first bent portion and an angle of inclination of the second bent portion in the director member are greater than or equal to 5° and less than or equal to 14°.

4. The antenna apparatus of claim 2, wherein the director member comprises a first bent portion connected between the first end portion and the center portion, and a second bent portion connected between the second end portion and the center portion, and
wherein each of lengths of the first and second bent portions is longer than a length of the center portion, and longer than each of lengths of the first and second end portions.

5. The antenna apparatus of claim 1, each of widths of the first and second end portions of the director member is shorter than a width of the center portion of the director member.

6. The antenna apparatus of claim 1, wherein the director member is disposed to overlap with a space between the first pole and the second pole, in view of the forward direction.

7. The antenna apparatus of claim 1, wherein a combination shape of the first and second poles is a folded-dipole shape.

8. The antenna apparatus of claim 1, further comprising a director via connected to the director member.

9. The antenna apparatus of claim 8, further comprising a feed via connected between the feed line and the dipole antenna member.

10. The antenna apparatus of claim 1, further comprising:
a ground layer disposed in rear of the first and second poles; and
a second feed line electrically connected to the second pole,
wherein the feed line is electrically connected to the first pole, and
wherein the ground layer surrounds a portion of the feed line and surrounds a portion of the second feed line.

11. The antenna apparatus of claim 1, further comprising a ground layer disposed in rear of the first and second poles,
wherein a front boundary of the ground layer is recessed.

12. The antenna apparatus of claim 11, further comprising shielding vias disposed along to the front boundary of the ground layer.

13. The antenna apparatus of claim 12, wherein the director member is longer than a length of the first pole, longer than a length of the second pole, and shorter than a unified length of the first pole and the second pole.

14. The antenna apparatus of claim 13, wherein the director member comprises a first bent portion connected between the first end portion and the center portion, and a second bent portion connected between the second end portion and the center portion, and
wherein each of lengths of the first and second bent portions is longer than a length of the center portion, and longer than each of lengths of the first and second end portions.

15. The antenna apparatus of claim 11, further comprising at least one of second dipole antenna members disposed in front of the ground layer,
wherein the front boundary of the ground layer is further recessed in rear of the second dipole antenna members.

16. The antenna apparatus of claim 15, further comprising:
at least one of second director members disposed in front of at least one of the second dipole antenna members,
wherein at least one of the second director members is bent so that first and second end portions of at least one of the second director members are more forwardly positioned than a center portion of at least one of the second director members.

17. The antenna apparatus of claim 1, further comprising:
a ground layer disposed in rear of the first and second poles;
at least one of second dipole antenna members disposed in front of the ground layer; and
at least one of second director members disposed in front of at least one of the second dipole antenna members.

18. The antenna apparatus of claim 17, further comprising shielding vias disposed along to the front boundary of the ground layer.
